(19) United States
(12) Patent Application Publication
(10) Pub. No.: US 2019/0129771 A1
(43) Pub. Date: May 2, 2019

(54) BALANCED MESSAGE DISTRIBUTION IN DISTRIBUTED MESSAGE HANDLING SYSTEMS

(71) Applicant: Nokia Solutions and Networks Oy, Espoo (FI)

(72) Inventors: Ruichuan Chen, Stuttgart (DE); Yousef Amar, Frankfurt am Main (DE); Ivica Rimac, Remseck (DE); Istemi Ekin Akkus, Heidelberg (DE); Volker Hilt, Waiblingen (DE)

(73) Assignee: Nokia Solutions and Networks Oy, Espoo (FI)

(21) Appl. No.: 15/794,440

(22) Filed: Oct. 26, 2017

(51) Int. Cl. G06F 9/54; H04W 4/12; G06F 17/30; G06F 12/0875

(52) U.S. Cl. CPC G06F 9/546; H04W 4/12; G06F 2212/60; G06F 12/0875; G06F 17/30964

(57) ABSTRACT

The present disclosure generally discloses improvements to computer performance in message handling based on a message handling capability for supporting handling of messages in a distributed message handling system. The message handling capability may be configured to support balanced distribution of messages in a distributed message handling system. The message handling capability may be configured to support, in a distributed message handling system including a set of producers and a set of consumers exchanging messages via a distributed message bus including a set of message queues, balanced distribution of messages by producers to message queues for making the messages available to consumers.

### TECHNICAL FIELD

The present disclosure relates generally to network technology and, more particularly but not exclusively, to handling of messages in message handling systems.

### BACKGROUND

Message handling systems may be used to handle various types of messages that may be associated with various types of services or applications. Message handling systems may be centralized systems or distributed systems. Message handling in distributed message handling systems may be complicated. Distribution of messages and, in particular, balanced distribution of messages, in distributed message handling systems also may be complicated.

### SUMMARY

The present disclosure generally discloses a message handling capability for supporting handling of messages in a distributed message handling system.

In at least some embodiments, an apparatus is provided. The apparatus is configured to support handling of messages in a message handling system. The apparatus includes a processor and a memory communicatively connected to the processor. The processor is configured to determine, for each of a plurality of queues in a set of queues, a queue length of the respective queue and a service rate of the respective queue. The processor is configured to determine, for each of the queues based on the respective queue lengths of the queues and the respective service rates of the queues, an expected waiting time of messages in the respective queue. The processor is configured to select, from the set of queues, a subset of queues including two or more of the queues in the set of queues. The processor is configured to select, from the subset of queues based on the respective expected waiting times of the respective queues in the subset of queues, a target queue to which to send a message. In at least some embodiments, a non-transitory computer-readable storage medium stores instructions which, when executed by a computer, cause the computer to perform a corresponding method for supporting handling of messages in a message handling system. In at least some embodiments, a corresponding method for supporting handling of messages in a message handling system is provided.

In at least some embodiments, an apparatus is provided. The apparatus is configured to support handling of messages in a message handling system. The apparatus includes a processor and a memory communicatively connected to the processor. The processor is configured to determine, for each of a plurality of queues in a set of queues based on respective queue lengths of the respective queues and respective service rates of the respective queues, an expected waiting time of messages in the respective queue. The processor is configured to select, from the set of queues, a subset of queues including two or more of the queues in the set of queues. The processor is configured to select, from the subset of queues based on the respective expected waiting times of the respective queues in the subset of queues, a target queue to which to send a message. In at least some embodiments, a non-transitory computer-readable storage medium stores instructions which, when executed by a computer, cause the computer to perform a corresponding method for supporting handling of messages in a message handling system. In at least some embodiments, a corresponding method for supporting handling of messages in a message handling system is provided.

### BRIEF DESCRIPTION OF THE DRAWINGS

The teachings herein can be readily understood by considering the following detailed description in conjunction with the accompanying drawings, in which:

FIG. 1 depicts a distributed message handling system configured to support distributed handling of messages exchanged between producers and consumers based on a distributed message bus;

FIG. 2 depicts a distributed message handling system for illustrating relationships between producers and consumers of the distributed message handling system and message queues of a distributed message bus of the distributed message handling system;

FIG. 3 depicts a producer of a distributed message handling system for illustrating a message distribution capability whereby the producer determines distribution of messages to message queues of a distributed message bus of the distributed message handling system;

FIG. 4 depicts an embodiment of a method for use by a producer of a distributed message handling system for distributing messages to message queues of a distributed message bus of the distributed message handling system;

FIG. 5 depicts an embodiment of a method for use by a producer of a distributed message handling system for distributing messages to message queues of a distributed message bus of the distributed message handling system; and

FIG. 6 depicts a high-level block diagram of a computer suitable for use in performing various functions presented herein.

To facilitate understanding, identical reference numerals have been used, where possible, to designate identical elements that are common to the figures.

### DETAILED DESCRIPTION

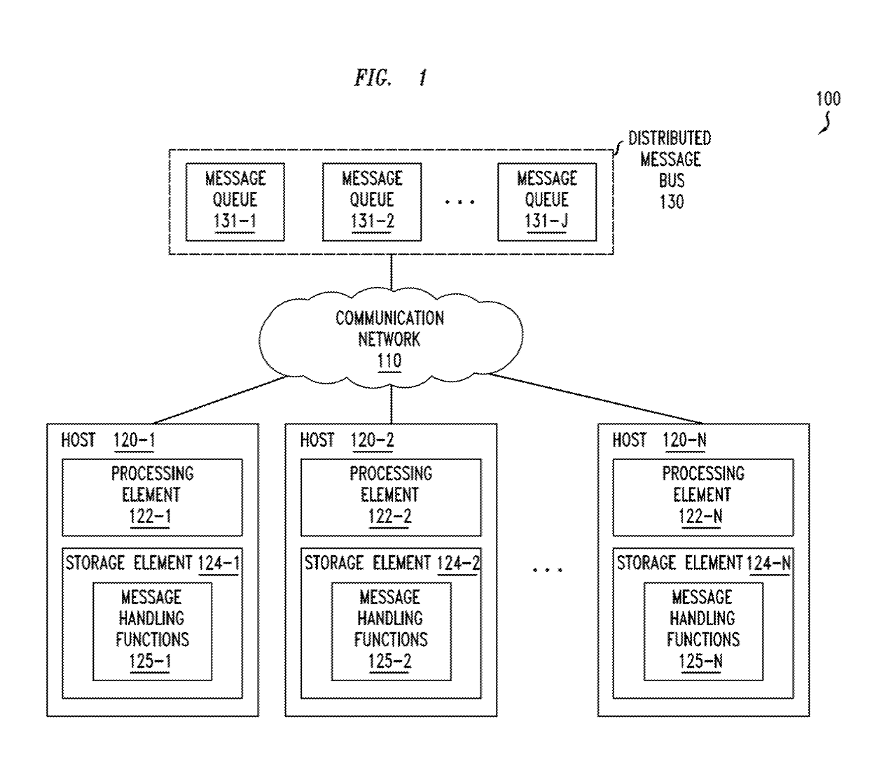

The present disclosure generally discloses improvements to computer performance in message handling based on a message handling capability for supporting handling of messages in a distributed message handling system. The message handling capability may be configured to support balanced distribution of messages in a distributed message handling system. The message handling capability may be configured to support, in a distributed message handling system including a set of producers and a set of consumers exchanging messages via a distributed message bus including a set of message queues, balanced distribution of messages by producers to message queues to make the messages available to consumers. The message handling capability may be configured to support balanced distribution of messages by producers to message queues to make the messages available to consumers based on message distribution processes executed by the producers. The message distribution process by which a producer selects a message queue to which a message is provided may be based on a combination of basic queuing decisions (e.g., a “selecting the best of two random queues” strategy, a shortest expected delay routing strategy, or the like), stale queue length information of the message queues, and estimation of service rates of message queues based on application of convolutions and heuristics to stale queue length information of the message queues. The message distribution process by which a producer selects a message queue to which a message is provided may be based on a combination of a “selecting the best of two random queues” strategy with a shortest expected delay routing strategy in order to generate an optimal or near-optimal message distribution strategy (here, the optimal message distribution strategy may assume the ideal knowledge of the actual service rates, and the cache refresh interval is zero). The message distribution process by which a producer selects message queues to which messages are provided may be configured to determine the message queues to which messages are to be provided, in a manner for reducing or even minimizing waiting time of messages in the message queues, based on stale queue length information of the message queues (e.g., based on use of a combination of the queue length information of the message queues and service rates estimated based on the queue length information of the message queues to determine expected waiting times of the message queues for use in determining distribution of messages to the message queues). The message distribution process by which a producer selects a message queue to which a message is provided may include determining respective queue lengths and service rates of the message queues, determining respective message waiting times of the message queues based on the respective queue lengths and service rates of the message queues, selecting a subset of the message queues, and selecting a target message queue to which to provide the message based on the expected waiting times of the message queues in the subset of message queues. The distributed message handling system may be configured to provide a scalable messaging layer for supporting exchanging of messages between producers and consumers. It will be appreciated that, for many practical applications, the tradeoff between decentralization and repeating of queries and storing of duplicate data by the producers weighs in the favor of decentralization. It will be appreciated that these and various other embodiments and advantages and potential advantages of the message handling capability may be further understood by way of reference to the example distributed message handling system of FIG. 1.

FIG. 1 depicts a distributed message handling system configured to support distributed handling of messages exchanged between producers and consumers based on a distributed message bus.

The distributed message handling system 100 includes a communication network 110, a set of hosts 120-1-120-N (collectively, hosts 120), and a distributed message bus (DMB) 130.

The communication network 110 may be any type of communication network configured to support communications within the distributed message handling system 100. The communication network 110 may be any type of communication network that is configured to support communications of the hosts 120 and the DMB 130 (e.g., communication of messages from ones of the hosts 120 operating as producers of the messages to the DMB 130, communication of messages from the DMB 130 to ones of the hosts 120 operating as consumers of the messages, communication of message processing responses from hosts 120 based on processing of messages by ones of the hosts 120 operating as consumers of the messages, or the like, as well as various combinations thereof). The communication network 110 may include one or more wireline communication networks, one or more wireless communication networks, or the like, as well as various combinations thereof). The communication network 110 may include various other communication systems or capabilities which may be used to support communications of the hosts 120 and the DMB 130.

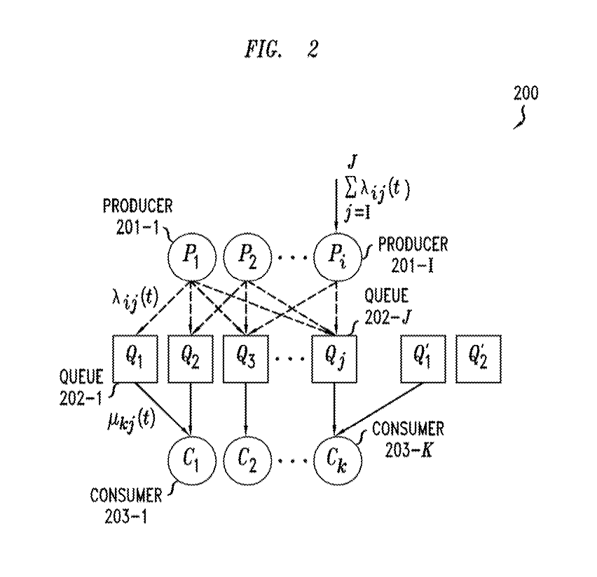

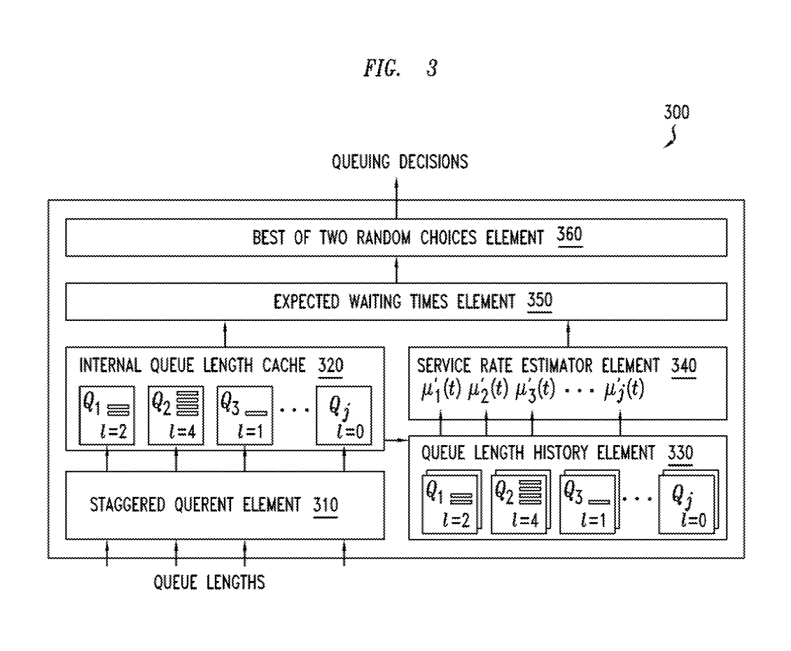

The hosts 120 may be any types of hosts configured to support handling of messages within the distributed message handling system 100. The hosts 120 each may be configured to operate as producers of messages, consumers of messages, or both. The hosts 120 include respective sets of elements configured to enable the hosts 120 to support handling of messages. The hosts 120 include respective processing elements 122 (illustratively, processing elements 122-1-122-N of hosts 120-1-120-N, respectively) configured to enable the hosts 120 to provide various message handling functions discussed herein (e.g., sending of messages when operating as a producer of the messages, receiving and processing of messages when operating as a consumer of the messages, or the like, as well as various combinations thereof). The hosts 120 include respective storage elements 124 (illustratively, storage elements 124-1-124-N of hosts 120-1-120-N, respectively) storing message handling functions 125 (illustratively, message handling functions 125-1-125-N of hosts 120-1-120-N, respectively) configured for use by the hosts 120 to handle messages at the hosts 120. The hosts 120 may be implemented in various ways (e.g., the hosts 120 may be physical hosts (e.g., servers), virtual hosts (e.g., virtual machines (VMs), virtual containers (VCs), or the like), or the like, as well as various combinations thereof), may be distributed in various ways (e.g., physical hosts that are geographically distributed, virtual hosts that are distributed across physical servers which may or may not be geographically distributed, or the like, as well as various combinations thereof), or the like, as well as various combinations thereof. The operation of hosts 120 operating as producers for distributing messages to DMB 130 may be further understood by way of reference to FIG. 2 and FIG. 3.

The DMB 130 is configured to support distributed queuing of messages for the hosts 120. The DMB 130 is configured to receive messages from hosts 120 operating as message producers (which may be referred to more generally as producers), store messages, and provide messages to hosts 120 operating as message consumers (which may be referred to more generally as consumers). The DMB 130 includes a set of message queues 131-1-131-J (collectively, message queues 131) configured to store messages being exchanged between hosts 120 operating as producers and hosts 120 operating as consumers. The message queues 131 are configured to store messages received from producers. The message queues 131 may store messages received from producers until conditions cause the messages to be removed from the message queues 131 (e.g., until the messages are requested by consumers, until expiration of a timer where messages are stored for a configurable length of time, or the like, as well as various combinations thereof). The message queues 131 have various operating parameters associated therewith, including queue length, service rate, and so forth. The message queues 131 may be distributed within a single node or distributed across multiple nodes (e.g., one message queue 131 per node, one or more message queues 131 per node, or the like), thereby providing scalability and resilience.

The hosts 120 and the DMB 130 cooperate to support communication of messages between hosts 120. A host 120 operating as a producer, for each message to be provided by the host 120 to the DMB 130, determines which of the message queues 131 of the DMB 130 to which the message is to be provided and sends the message to that message queue 131 of the DMB 130 for storage. It is noted that this process may be further understood by way of reference to FIG. 2 and FIG. 3. A host 120 operating as a consumer, for each message to be processed by the host 120, determines which of the message queues 131 of the DMB 130 from which the message is to be retrieved and retrieves the message from that message queue 131 of the DMB 130 for processing.

The distributed message handling system 100 may be configured to support handling of messages for various types of applications and services. For example, the messages may be related to user activity tracking (e.g., website activity such as page views, searches, or the like), operational monitoring (e.g., aggregating statistics from distributed applications, aggregating statistics from distributed services, or the like), log handling (e.g., log aggregation, event sourcing, commit logs for resynchronization, or the like), streaming processing (e.g., processing pipelines for constructing responses to queries (e.g., database queries, web searches, or the like), recommending articles, or the like), network function virtualization (e.g., handling of messages between virtual network functions), or the like, as well as various combinations thereof. As discussed above, there are producers of such messages and consumers of such messages, which may vary for different application or service types. The relationships between such producers and consumers, via a distributed message bus, may be further understood by way of reference to FIG. 2.

It will be appreciated that the distributed message handling system 100, although primarily presented herein as being organized in a particular way, may be organized in many other ways. For example, although primarily presented herein as using specific numbers, types, or arrangements of elements, distributed message handling system 100 may use various other numbers, types, or arrangements of elements (e.g., using other numbers, types, or arrangements of communication networks 110, using other numbers, types, or arrangement of hosts 120, using other numbers types or arrangements of message queues 131, or the like, as well as various combinations thereof). For example, although primarily presented with respect to embodiments in which queuing of messages is provided using message queues 131 in the DMB 130 where the DMB 130 is independent of the hosts 120, in at least some embodiments at least a portion of the message queues 131 may be provided on the hosts 120 (e.g., some message queues 131 may be implemented on hosts 120 and some message queues 131 may be implemented on the DMB 130, all message queues 131 may be implemented on hosts 120 such that the DMB 130 is provided by the hosts 120, or the like). It will be appreciated that the distributed message handling system 100 may be organized in various other ways.

FIG. 2 depicts a distributed message handling system for illustrating relationships between producers and consumers of the distributed message handling system and message queues of a distributed message bus of the distributed message handling system. The distributed message handling system 200 includes a set of producers 201-1-201-I (denoted as producers 201 as well as producers Pᵢ), a set of queues 202-1-202-J (denoted as queues 202 as well as queues Qⱼ), and a set of consumers 203-1-203-K (denoted as consumers 203 as well as consumers Cₖ). The producers 201 may be hosts 120 of FIG. 1, the queues 202 may be message queues 131 of FIG. 1, and the consumers 203 may be hosts 120 of FIG. 1. It is noted that the additional queues that are illustrated (Q′₁, Q′₂, and so forth) represent that fact that the set of queues Qⱼ being considered by a producer Pᵢ as potential queues to which messages may be provided may be a subset of the full set of queues available in the distributed message bus (e.g., a subset of queues of the distributed message bus that are available to the producer Pᵢ, a subset of queues of the distributed message bus that are to be used by the producer Pᵢ for messages of a particular message type or topic, or the like, as well as various combinations thereof) and, similarly, that the set of queues Qⱼ being considered by a consumer Cₖ as potential queues from which messages may be obtained may be a subset of the full set of queues available in the distributed message bus (e.g., a subset of queues of the distributed message bus that are available to the consumer Cₖ, a subset of queues of the distributed message bus that are to be used by the consumer Cₖ for messages of a particular message type or topic, or the like, as well as various combinations thereof).

The distributed message handling system 200 illustrates the paths that messages follow between producers Pᵢ and consumers Cₖ, with each message starting at one of the producers Pᵢ, passing through one of the queues Qⱼ, and being consumed by one of the consumers Cₖ. The sending rate λᵢ of a producer Pᵢ is a superposition of the sending rates λᵢⱼ of the producer Pᵢ to each of the j queues Qⱼ at a given time slot t (which may be expressed as λᵢ(t)=Σⱼ₌₁^{J}λᵢⱼ(t)) and, similarly, the arrival rate λⱼ of a queue Qⱼ is a superposition of the arrival rates λᵢⱼ to the queue Qⱼ from each of the i producers Pᵢ at a given time slot t (which may be expressed as λⱼ(t)=Σᵢ₌₁^{I}λᵢⱼ(t)). The service rate uₖ of a consumer Cₖ is a superposition of the service rates uₖⱼ of the consumer Cₖ by each of the j queues Qⱼ at a given time slot t (which may be expressed as μₖ(t)=Σⱼ₌₁^{J}μₖⱼ(t)) and, similarly, the service rate μᵢ(t) of a queue Qⱼ (which is the rate at which messages are removed from the queue Qⱼ by the consumers Cₖ) is a superposition of the service rates uₖⱼ from the queue Qⱼ to each of the k consumers Cₖ at a given time slot t (which may be expressed as μⱼ(t)=Σₖ₌₁^{K}μₖⱼ(t)).

The distributed message handling system 200 is configured to support load balancing of messages. In order to support load balancing, for each of the queues Qⱼ the arrival rate λⱼ of the queue Qⱼ should be proportional to the service rate uⱼ of the queue Qⱼ. The producers Pᵢ distribute messages to the queues Qⱼ in a manner that supports such load balancing. However, the problem of configuring the producers Pᵢ to distribute messages to the queues Qⱼ in a manner that supports such load balancing may be non-trivial under the following constraints: (1) the producers Pᵢ may make message distribution decisions based on queue lengths of the queues Qⱼ, but the time to query the queues Qⱼ to retrieve the queue lengths may be significant, leading to stale queue length information at the producers Pᵢ and (2) the consumers Cₖ may have different, and potentially volatile, service rates uⱼ due to various conditions (e.g., different hardware resources being used by different consumers Cₖ, imbalanced assignments when the number of queues Qⱼ is not a multiple of the number of consumers Cₖ, additional load on consumers Cₖ from other queues (e.g., for other applications or services, for other message types, for other topics, or the like), extrinsic processes running on the same hosts as the consumers Cₖ, or the like, as well as various combinations thereof).

The producers Pᵢ are configured to distribute messages to queues Qⱼ based on a message distribution process.

The message distribution process used by a producer Pᵢ to select a target queue Qⱼ to which a message is provided may be based on various types of information which may be determined by the producer Pᵢ. The message distribution process used by a producer Pᵢ to select a target queue Qⱼ to which a message is provided may be based on queue lengths of the queues Qⱼ and service rates of the queues Qⱼ, which may be determined in various ways. The queue lengths of the queues Qⱼ may be stale queue lengths. The queue lengths of the queues Qⱼ may be cached at the producer Pᵢ based on queries to the queues Qⱼ for queue length information (e.g., queue length values of the queues Qⱼ). The service rates of the queues Qⱼ may be determined based on queue length history information of the queues Qⱼ, which may be determined based on the queue lengths of the queues Qⱼ cached at the producer Pᵢ. The message distribution process used by a producer Pᵢ to select a target queue Qⱼ to which a message is provided may be based on expected waiting times of messages in the queues Qⱼ (e.g., equal to or indicative of the length of time that messages are expected to wait in the respective queue Qⱼ), which may be determined based on the respective queue lengths of the queues Qⱼ and the respective service rates of the queues Qⱼ. The message distribution process used by a producer Pᵢ to select a target queue Qⱼ to which a message is provided may be based on selection of a subset of queues Qⱼ (which may be denoted as a subset of queues Q′ⱼ) in the set of queues Qⱼ, from which the target queue Qⱼ may then be selected based on the expected waiting times of messages in the queues Qⱼ in the subset of queues Q′ⱼ. The message distribution process used by a producer Pᵢ to select a target queue Qⱼ to which a message is provided, as discussed further below, may be based various other types of information, techniques, or the like, as well as various combinations thereof.

The message distribution process used by a producer Pᵢ to select a target queue Qⱼ to which a message is provided may include (1) determining, for each of queues Qⱼ, a queue length of the respective queue Qⱼ and a service rate of the respective queue Qⱼ, (2) determining, for each of the queues Qⱼ based on the respective queue lengths of the respective queues Qⱼ and the respective service rates of the respective queues Qⱼ, an expected waiting time of messages in the respective queue Qⱼ, (3) selecting, from the set of queues Qⱼ, a subset of queues Q′ⱼ including two or more of the queues Qⱼ in the set of queues Qⱼ and (4) selecting, from the subset of queues Q′ⱼ based on the respective expected waiting times of the respective queues Qⱼ in the subset of queues Q′ⱼ, the target queue Qⱼ to which to send the message.

The producer Pᵢ may determine the queue lengths of the queues Qⱼ in various ways. The queue lengths of the queues Qⱼ may be determined by the producer Pᵢ from queue length values cached by the producer Pᵢ based on queries, by the producer Pᵢ to the queues Qⱼ, for queue length information. The cached queue length values may be used since the queue length information of the queues Qⱼ may be updated at a slower rate than the message arrivals. The producer Pᵢ may query the queues Qⱼ for queue length information to be cached by the producer Pᵢ once per cache refresh interval (i.e., each queue Qⱼ is queried by the producer Pᵢ one time during each cache refresh interval of the cache of the producer Pᵢ). The cache refresh interval of the producer Pᵢ may be based on a minimum query delay for the queries by the producer Pᵢ to the queues Qⱼ for the queue length information of the respective queues Qⱼ. The minimum query delay for the queries by the producer Pᵢ to the queues Qⱼ may be equal to or about equal to the roundtrip time between the producer Pᵢ and the queues Qⱼ. The queries by the producer Pᵢ to the queues Qⱼ within a given cache refresh interval may be distributed uniformly, or substantially uniformly, over the given cache refresh interval. This distribution may prevent the producer Pᵢ from initiating many queries at the same time. The queries by the producer Pᵢ to the queues Qⱼ may be out of phase with queries by the other producers Pᵢ. This phase offset may prevent multiple producers Pᵢ from querying the same query Qⱼ at the same time, thereby reducing or minimizing any potential delays caused by congestion.

The producer Pᵢ may determine the service rates of the queues Qⱼ in various ways.

The producer Pᵢ may determine the service rates of the queues Qⱼ based on various types of information, techniques, or the like. The producer Pᵢ may determine the service rates of the queues Qⱼ based on queue length history information of the queues Qⱼ that is maintained by the producer Pᵢ. The producer Pᵢ may determine the queue length history information of the queues Qⱼ from the queue length values cached by the producer Pᵢ based on queries by the producer Pᵢ to the queues Qⱼ (e.g., updating the queue length history information of the queues Qⱼ based on the queue length values received by the producer Pᵢ based on queries to the queues Qⱼ). The queue length history information may include x (x≥1) sets of queue length values cached by the producer Pᵢ (e.g., the x most recently sets of queue length values cached by the producer Pᵢ or various other combinations of queue length values cached by the producer Pᵢ). The producer Pᵢ may determine the service rates of the queues Qⱼ based on application of convolutions to the queue length history information of the queues Qⱼ that is maintained by the producer Pᵢ. The convolutions used by the producer Pᵢ for estimating service rates of the queues Qⱼ from queue length history information of the queues Qⱼ can be fit for purpose. The producer Pᵢ may determine the service rates of the queues Qⱼ based on application of heuristics to the queue length history information of the queues Qⱼ that is maintained by the producer Pᵢ. The producer Pᵢ may determine the service rates of the queues Qⱼ based on a combination of convolutions and heuristics.

The producer Pᵢ may determine the service rates of the queues Qⱼ based on various types of assumptions, techniques, or the like. The producer Pᵢ may determine the service rates of the queues Qⱼ based on an assumption that like messages (e.g., same message type, similar message type, same topic, or the like) have similar service rates. The producer Pᵢ may determine the service rates of the queues Qⱼ based on an assumption that service rates of queues Qⱼ may vary based on various conditions (e.g., new queue assignments, extrinsic processes running on the hosts of the consumers Ck, or the like). In cases in which such conditions are relatively slow to change, the producer Pᵢ may determine the service rates of the queues Qⱼ based on a simple moving average with a constant window size. In cases in which such conditions change or may change relatively quickly, the producer Pᵢ may determine the service rates of the queues Qⱼ based on more accurate mechanisms, such as application of a filter (e.g., a Kalman filter or other suitable type of filter), machine learning, deep learning, or the like, as well as various combinations thereof. The determination of service rates of the queues Qⱼ also may be based on additional knowledge (e.g., daily service rate patterns, seasonal service rate patterns, or the like, as well as various combinations thereof).

It will be appreciated that various combinations of such mechanisms may be used by the producer Pᵢ may determine the service rates of the queues Qⱼ.

The producer Pᵢ may, for each of the queues Qⱼ, determine the expected waiting time of messages in the respective queue Qⱼ based on the queue length of the respective queue Qⱼ and the service rate of the respective queue Qⱼ. The producer Pᵢ may, for each of the queues Qⱼ, determine the expected waiting time of messages in the respective queue Qⱼ based on dividing of the queue length of the respective queue Qⱼ by the service rate of the respective queue Qⱼ. It is noted that the expected waiting times of the respective queues Qⱼ may be used as or indicative of queue selection probabilities for use in selecting queues Qⱼ to which messages are provided by the producer Pᵢ.

The producer Pᵢ may select the subset of queues Q′ⱼ from the set of queues Qⱼ in various ways. The producer Pᵢ may select the subset of queues Q1ⱼ from the set of queues Qⱼ randomly. The subset of queues Q′ⱼ may include two of the queues Qⱼ from the set of queues Qⱼ (e.g., for use in applying a “best of two random choices” strategy in selecting the target queue Qⱼ).

The producer Pᵢ may select the target queue Qⱼ to which the message is provided, from the subset of queues Q′ⱼ, by selecting the one of the queues Qⱼ in the subset of queues Q′ⱼ that has the lowest expected waiting time (e.g., similar to a shortest expected delay routing strategy).

The message distribution process used by a producer Pᵢ to select a target queue Qⱼ to which a message is provided may include (1) determining, for each of queues Qⱼ based on a queue length of the respective queue Qⱼ and a service rate of the respective queue Qⱼ, an expected waiting time of the respective queue Qⱼ (equal to or indicative of the length of time that messages are expected to wait in the respective queue Qⱼ), (2) selecting, from the set of queues Qⱼ, a subset of queues Q′ⱼ including two or more of the queues Qⱼ in the set of queues Qⱼ, and (3) selecting, from the subset of queues Q′ⱼ based on the respective expected waiting times of the respective queues Qⱼ in the subset of queues Q′ⱼ, the target queue Qⱼ to which to send the message.

The producer Pᵢ may be configured to select the target queue Qⱼ to which a message is to be provided based on various other types of information, based on determination of information in various other ways, or the like, as well as various combinations thereof.

It is noted that the distributed message handling system 200 may be configured to be dynamically adjusted to be less or more aggressive based on the volatility of the service rates of the queues Qⱼ.

It is noted that an example of a producer Pᵢ configured to distribute messages to queues based on expected waiting times of the queues is presented with respect to FIG. 3.

FIG. 3 depicts a producer of a distributed message handling system for illustrating a message distribution capability whereby the producer determines distribution of messages to message queues of a distributed message bus of the distributed message handling system.

The producer 300 is configured to distribute messages to message queues of a distributed message bus of a distributed message handling system, which is omitted from FIG. 3 for purposes of clarity.

The producer 300 includes a staggered querent element 310, an internal queue length cache 320, a queue length history element 330, a service rate estimator 340, an expected waiting times element 350, and a best of two random choices element 360.

The staggered querent element 310 is configured to control queries to the queues for the queue lengths of the queues. The staggered querent element 310 is configured to provide the queue lengths of the queues to the internal queue length cache 320 for caching of the queue lengths of the queues.

The internal queue length cache 320 is configured to receive the queue lengths of the queues from the staggered querent element 310. The internal queue length cache 320 is configured to cache the queue lengths of the queues. The internal queue length cache 320 is configured to provide the queue lengths of the queues to the queue length history element 330 and to the expected waiting times element 350.

The queue length history element 330 is configured to receive the queue lengths of the queues from the internal queue length cache 320, determine queue length history information for the queues based on the queue lengths of the queues, and maintain the queue length history information of the queues. The queue length history information may include one or more sets of queue length values from the internal queue length cache 320, additional historical queue length information determined based on one or more sets of queue length values from the internal queue length cache 320, or the like, as well as various combinations thereof. It will be appreciated that, although only two sets of queue length values from the internal queue length cache 320 are illustrated, the queue length history information may include or may be based on less or more sets of queue length values from the internal queue length cache 320. The queue length history element 330 is configured to provide the queue length history information of the queues to the service rate estimator 340 for use in computing estimated service rates of the queues.

The service rate estimator 340 is configured to receive the queue length history information of the queues from the queue length history element 330, compute the estimated service rates of the queues based on the queue length history information of the queues, and provide the estimated service rates of the queues to the expected waiting times element 350.

The expected waiting times element 350 is configured to receive the queue lengths of the queues from the internal queue length cache 320 and the service rates of the queues from the service rate estimator 340, determined expected waiting times for the queues based on the queue lengths of the queues and the service rates of the queues, and provide the expected waiting times for the queues to the best of two random choices element 360.

The best of two random choices element 360 is configured to receive the expected waiting times for the queues from the expected waiting times element 350. The best of two random choices element 360 is configured to select two of the queues randomly. The best of two random choices element 360 is configured to select, from the two queues selected randomly and based on the expected waiting times for the two queues selected randomly, a selected queue to which a message is provided. The best of two random choices element 360 is configured to provide an indication of the selected queue to which a message is provided to an element configured to provide the message to the selected queue to which the message is provided.

It will be appreciated that, although omitted for purposes of clarity, the producer 300 may then initiate providing the message to the selected queue.

It will be appreciated that the functions supported by the producer 300 may be provided in various ways. In at least some embodiments, the elements that update the queue length information (e.g., the staggered querent element 310 and the queue length history element 330) may be provided using one process or thread of the producer 300 while the elements that determine the queuing decisions and, thus, the partitioning of the messages across the queues (e.g., the expected waiting times element 350 and the best of two random choices element 360), may be provided using another process or thread of the producer 300. It will be appreciated that the various functions may be distributed or combined in various ways.

It will be appreciated that the functions supported by the producer 300 may be provided in various other ways (e.g., using fewer or more elements, using distribution of functions across elements in other ways, or the like, as well as various combinations thereof).

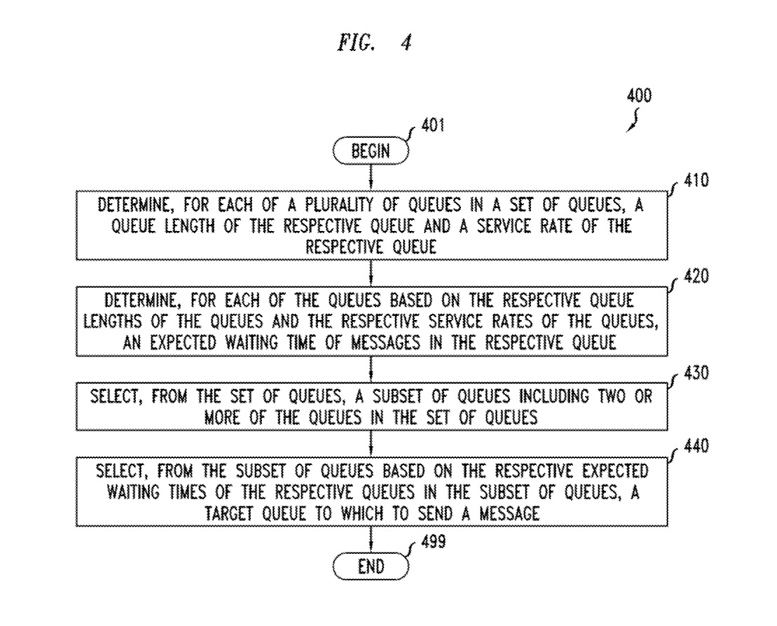

FIG. 4 depicts an embodiment of a method for use by a producer of a distributed message handling system for distributing messages to message queues of a distributed message bus of the distributed message handling system. The method 400 for distributing messages to message queues of a distributed message bus of a distributed message handling system may be performed by a host (e.g., a host 120 of FIG. 1) operating as a producer. The method 400 for distributing messages to message queues of a distributed message bus of the distributed message handling system may be performed by a producer as presented with respect to FIG. 2 or FIG. 3. It will be appreciated that, although primarily presented herein as being performed serially, at least a portion of the functions of method 400 may be performed contemporaneously or in a different order than as presented in FIG. 4.

At block 401, method 400 begins.

At block 410, determine, for each of a plurality of queues in a set of queues, a queue length of the respective queue and a service rate of the respective queue.

At block 420, determine, for each of the queues based on the respective queue lengths of the queues and the respective service rates of the queues, an expected waiting time of messages in the respective queue.

At block 430, select, from the set of queues, a subset of queues including two or more of the queues in the set of queues.

At block 440, select, from the subset of queues based on the respective expected waiting times of the respective queues in the subset of queues, a target queue to which to send a message.

At block 499, method 400 ends.

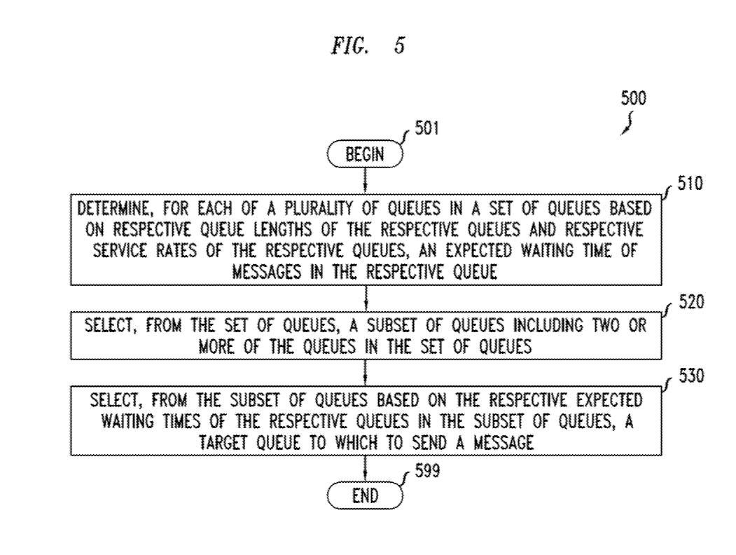

FIG. 5 depicts an embodiment of a method for use by a producer of a distributed message handling system for distributing messages to message queues of a distributed message bus of the distributed message handling system. The method 500 for distributing messages to message queues of a distributed message bus of a distributed message handling system may be performed by a host (e.g., a host 120 of FIG. 1) operating as a producer. The method 500 for distributing messages to message queues of a distributed message bus of the distributed message handling system may be performed by a producer as presented with respect to FIG. 2 or FIG. 3. It will be appreciated that, although primarily presented herein as being performed serially, at least a portion of the functions of method 500 may be performed contemporaneously or in a different order than as presented in FIG. 5.

At block 501, method 500 begins.

At block 510, determine, for each of a plurality of queues in a set of queues based on respective queue lengths of the respective queues and respective service rates of the respective queues, an expected waiting time of messages in the respective queue.

At block 520, select, from the set of queues, a subset of queues including two or more of the queues in the set of queues.

At block 530, select, from the subset of queues based on the respective expected waiting times of the respective queues in the subset of queues, a target queue to which to send a message.

At block 599, method 500 ends.

It will be appreciated that, although primarily presented herein with respect to using embodiments of the message handling capability to provide improved message handling for a distributed message bus, various embodiments of the message handling capability may be used to provide improved message handling for various other types of message buses (e.g., non-distributed message buses or other types of message buses supporting distribution of messages between message queues).

It will be appreciated that various embodiments of the message handling capability may provide various advantages or potential advantages. For example, various embodiments of the message handling capability may produce optimal or near-optimal message partitioning decisions (and, therefore, message partitioning) under various constraints. For example, various embodiments of the message handling capability may be configured to determine the queues to which messages are to be provided, in a manner for reducing or even minimizing waiting times of messages in the queues, based on stale queue length information of the queues (e.g., based on use of a combination of the queue length information of the queues and service rates estimated based on the queue length information of the queues to determine expected waiting times of the queues for use in determining distribution of messages to the queues). For example, various embodiments of the message handling capability, by having the producers maintain respective independent queue length caches, obviate the need for use of a central component to maintain the queue length information of the queues and, thus, avoids a potential bottleneck point of failure. For example, various embodiments of the message handling capability may enable producers to distribute messages based on knowledge of the state of the queues (e.g., queue length information based on queries to the queues) but without needing knowledge regarding consumer assignments, thereby supporting improved scalability. For example, various embodiments of the message handling capability may be configured to support distribution of messages on a message bus where there is not uniformity between consumers of the message bus and without a need to assume uniformity between consumers of the message bus. For example, various embodiments of the message handling capability may be configured to provide relatively low latency for consumers of a message bus. For example, various embodiments of the message handling capability may produce optimal or near-optimal job scheduling to minimize message waiting time on the message bus. For example, various embodiments of the message handling capability may improve the scalability of message bus systems. For example, various embodiments of the message handling capability may be applied to various types of message bus systems in order to improve various aspects of message handling by message bus systems. It will be appreciated that, for most practical applications, the trade-off between decentralization and repeating queries and storing duplicate data weighs in the favor of decentralization, because the number of queues is typically in the same order of magnitude as the number of producers. It will be appreciated that various embodiments of the message handling capability may provide various other advantages or potential advantages.

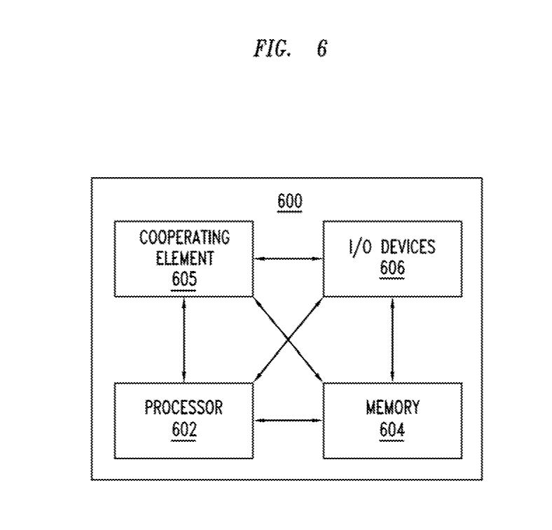

FIG. 6 depicts a high-level block diagram of a computer suitable for use in performing various functions described herein.

The computer 600 includes a processor 602 (e.g., a central processing unit (CPU), a processor having a set of one or more processor cores, or the like) and a memory 604 (e.g., a random access memory (RAM), a read only memory (ROM), or the like). The processor 602 and the memory 604 are communicatively connected.

The computer 600 also may include a cooperating element 605. The cooperating element 605 may be a hardware device. The cooperating element 605 may be a process that can be loaded into the memory 604 and executed by the processor 602 to implement functions as discussed herein (in which case, for example, the cooperating element 605 (including associated data structures) can be stored on a non-transitory computer-readable storage medium, such as a storage device or other storage element (e.g., a magnetic drive, an optical drive, or the like)).

The computer 600 also may include one or more input/output devices 606. The input/output devices 606 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices or elements (e.g., a tape drive, a floppy drive, a hard disk drive, a compact disk drive, or the like), or the like, as well as various combinations thereof.

It will be appreciated that computer 600 of FIG. 6 may represent a general architecture and functionality suitable for implementing functional elements described herein, portions of functional elements described herein, or the like, as well as various combinations thereof. For example, computer 600 may provide a general architecture and functionality that is suitable for implementing one or more of an element of communication network 110, a host 120 or a portion thereof, the DMB 130 or a portion thereof, or the like, as well as various combinations thereof.

It will be appreciated that the functions depicted and described herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits (ASIC), and/or any other hardware equivalents).

It will be appreciated that at least some of the functions discussed herein as software methods may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
determine, for each of a plurality of queues in a set of queues, a queue length of the respective queue and a service rate of the respective queue;
determine, for each of the queues based on the respective queue lengths of the queues and the respective service rates of the queues, an expected waiting time of messages in the respective queue;
select, from the set of queues, a subset of queues including two or more of the queues in the set of queues; and
select, from the subset of queues based on the respective expected waiting times of the respective queues in the subset of queues, a target queue to which to send a message.

2. The apparatus of claim 1, wherein the set of queues provides a distributed message bus for a distributed messaging system including a set of producers and a set of consumers.

3. The apparatus of claim 1, wherein the apparatus is associated with a producer of a distributed messaging system including a set of producers and a set of consumers.

4. The apparatus of claim 1, wherein, for at least one of the queues, the respective queue length of the respective queue and the respective service rate of the respective queue are determined based on respective sets of queue length values of the respective queues that are cached locally in a cache.

5. The apparatus of claim 1, wherein, for at least one of the queues, the respective queue length of the respective queue is determined based on a respective set of queue length values of the respective queue that is cached locally in a cache.

6. The apparatus of claim 1, wherein, for each of the queues, the respective queue length of the respective queue is determined based on a respective set of queue length values of the respective queue that is cached locally in a cache.

7. The apparatus of claim 6, wherein the respective sets of queue length values of the respective queues are updated based on respective queries to the respective queues for queue length information of the respective queues.

8. The apparatus of claim 7, wherein, within a cache refresh interval of the cache, the queries to the respective queues for the queue length information of the respective queues are distributed substantially uniformly over the cache refresh interval.

9. The apparatus of claim 8, wherein the cache refresh interval is based on a minimum query delay for the queries to the respective queues for the queue length information of the respective queues.

10. The apparatus of claim 8, wherein the apparatus is associated with a producer of a distributed messaging system including a set of producers and a set of consumers, wherein the queries to the respective queues for the queue length information of the respective queues are out of phase with queries by at least one other producer.

11. The apparatus of claim 1, wherein, for at least one of the queues, the service rate of the respective queue is determined based on queue length history information of the respective queue.

12. The apparatus of claim 11, wherein the queue length history information of the respective queue is determined based on a respective set of queue length values of the respective queue that is cached locally in a cache.

13. The apparatus of claim 11, wherein the service rate of the respective queue is determined based on application of at least one of a convolution or a heuristic to queue length history information of the respective queue.

14. The apparatus of claim 1, wherein, for at least one of the queues, the service rate of the respective queue is determined based on at least one of a simple moving average with a constant window size, a Kalman filter, or machine learning.

15. The apparatus of claim 1, wherein, for at least one of the queues, the service rate of the respective queue is determined based on an assumption that messages associated with a particular topic have similar service rates.

16. The apparatus of claim 1, wherein, for at least one of the queues, the expected waiting time of the respective queue is determined based on dividing of the queue length of the respective queue by the service rate of the respective queue.

17. The apparatus of claim 1, wherein the subset of queues is selected randomly from the set of queues.

18. The apparatus of claim 1, wherein the subset of queues includes two of the queues in the set of queues.

19. The apparatus of claim 1, wherein the target queue is one of the queues, from the subset of queues, having a lowest expected waiting time.

20. The apparatus of claim 1, wherein the processor is configured to:
send the message toward the target queue.

21. A method, comprising:
determining, by a processor for each of a plurality of queues in a set of queues, a queue length of the respective queue and a service rate of the respective queue;
determining, by the processor for each of the queues based on the respective queue lengths of the queues and the respective service rates of the queues, an expected waiting time of messages in the respective queue;
selecting, by the processor from the set of queues, a subset of queues including two or more of the queues in the set of queues; and
selecting, by the processor from the subset of queues based on the respective expected waiting times of the respective queues in the subset of queues, a target queue to which to send a message.

22. An apparatus, comprising:
a processor and a memory communicatively connected to the processor, the processor configured to:
determine, for each of a plurality of queues in a set of queues based on respective queue lengths of the respective queues and respective service rates of the respective queues, an expected waiting time of messages in the respective queue;
select, from the set of queues, a subset of queues including two or more of the queues in the set of queues; and
select, from the subset of queues based on the respective expected waiting times of the respective queues in the subset of queues, a target queue to which to send a message.
